(19) United States
(12) Patent Application Publication
(10) Pub. No.: US 2025/0248528 A1
(43) Pub. Date: Aug. 7, 2025

(54) AUTO-REGRESSION MECHANISM

(71) Applicant: Sizewise Rentals, L.L.C., Eden Prairie, MN (US)

(72) Inventors: Troy PARSON, Ellis, KS (US); Duane E. WENTE, III, Hays, KS (US); Matthew Ray ISLEY, Hays, KS (US); David Delroy DRISCOLL, JR., Milwaukee, WI (US)

(73) Assignee: Sizewise Rentals, L.L.C., Eden Prairie, MN (US)

(21) Appl. No.: 19/044,579

(22) Filed: Feb. 3, 2025

Related U.S. Application Data
(60) Provisional application No. 63/627,874, filed on Feb. 1, 2024.

(51) Int. Cl. A47C 20/04

(52) U.S. Cl. CPC A47C 20/04

(57) ABSTRACT

A hinge assembly for a bed includes a hinge guide assembly connected to a head section of the bed, and a bed frame assembly mounted portion connected to the bed frame assembly. The hinge guide assembly forms curved guide tracks that receive roller bearings mounted to the bed frame assembly mounted portion. The connection between the hinge guide assembly and roller bearings results in angular rotation of the head section relative to the bed frame assembly.

### CROSS-REFERENCE TO RELATED APPLICATIONS

This application claims priority in U.S. Patent Application Ser. No. 63/627,874, filed Feb. 1, 2024, the contents of which are hereby incorporated by reference in its entirety.

### BACKGROUND

The disclosed subject matter relates to beds with movable patient support components. Traditional beds have a head section that can pivot relative to the bed frame via hinge components. However, the pivoting hinge arrangement results in undesirable up and down movement of the head section when it is raised and lowered relative to the bed frame.

### SUMMARY

A parallel support system hinge assembly for use with a bed frame assembly includes components hingedly connected between a foot end and an opposite head end forming a patient support surface. The system and arrangement of components provides smooth and stable movement of a head section of a patient support surface of a bed when the head section is raised and lowered in relation to the bed frame assembly with minimal deflection of the hinge assembly. The system allows auto-regression of the head section away from the adjacent upper core section when raised, facilitating patient comfort when profiling the patient from a supine position where the foot section, lower core section, upper core section, and head section provide a generally flat surface parallel with the bed frame assembly, to a sitting position where the head section is in an angular position relative to the bed frame assembly.

The system uses a pair of hinge assemblies to guide the head section during movement. A hinge assembly includes a head section mounted portion and a bed frame assembly mounted portion. The head section mounted portion includes a hinge guide assembly connected to the head section by a hinge support assembly. The bed frame assembly mounted portion includes roller bearings, such as sealed roller bearings, mounted to the bed frame assembly by a frame plate assembly and a hinge bearing mount assembly. The roller bearings translate within guide tracks in the hinge guide assembly, thereby slidably interfacing the head section mounted portion guide with the bed frame assembly mounted portion when moved by an actuation assembly. The disclosed hinge assembly allows the head section to rotate upward and downward in an angular fashion relative to the bed frame. The hinge assembly arrangement of roller bearings within guide tracks results in an angular rotation of the head section relative to the bed frame, and limits undesirable vertical movement of the head section encountered with traditional pivoting hinge arrangements used to support head sections of traditional beds.

An actuation assembly moves the patient support surface portion of the head section between, and at any point along the path of travel between, a generally flat patient support position to a position at an angle relative to the bed frame assembly. The actuation assembly includes an actuator assembly connected to the bed frame assembly by a bed frame bracket, and connected to the head section by a drive assembly bracket.

### BRIEF DESCRIPTION OF THE DRAWINGS

The present disclosed subject matter is described herein with reference to the following drawing figures, with greater emphasis being placed on clarity rather than scale:

FIG. 1 is an isometric view from above of a bed frame assembly with a parallel support system embodying principles of the disclosed subject matter.

FIG. 2 is a side elevation view of FIG. 1.

FIG. 3 is a bottom plan view of the parallel support system.

FIG. 4 is an isometric view from the side, toward the foot of the bed frame assembly, of a guide plate.

FIG. 5 is an isometric view from above of a frame plate.

FIG. 6 is an isometric view from above, toward the head of the bed frame assembly, of a hinge support assembly.

FIG. 7 is an isometric view from the side of a bearing mount.

FIG. 8. is a plan view from below of the hinge bearing mount assembly.

FIG. 9 is an isometric view from above of the hinge bearing mount assembly.

FIG. 10 is an isometric view from below of the parallel support system.

FIG. 11 is an isometric view from below of the actuation assembly.

FIG. 12 is an isometric view from below of the bed frame bracket.

FIG. 13 is a side elevation view of a bed frame assembly in a semi-Fowler position.

### DETAILED DESCRIPTION

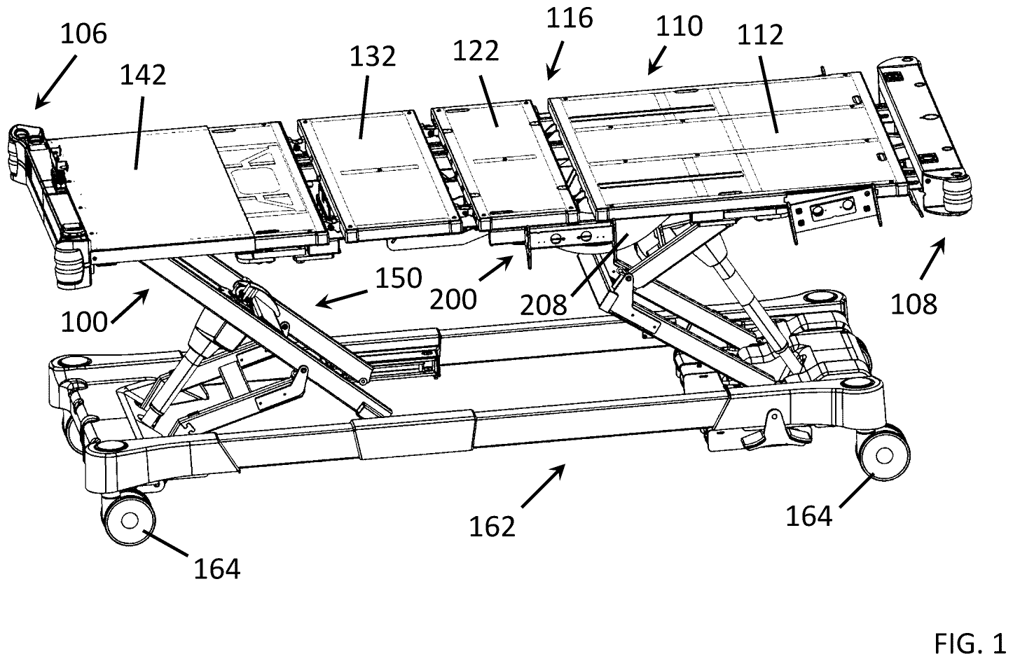

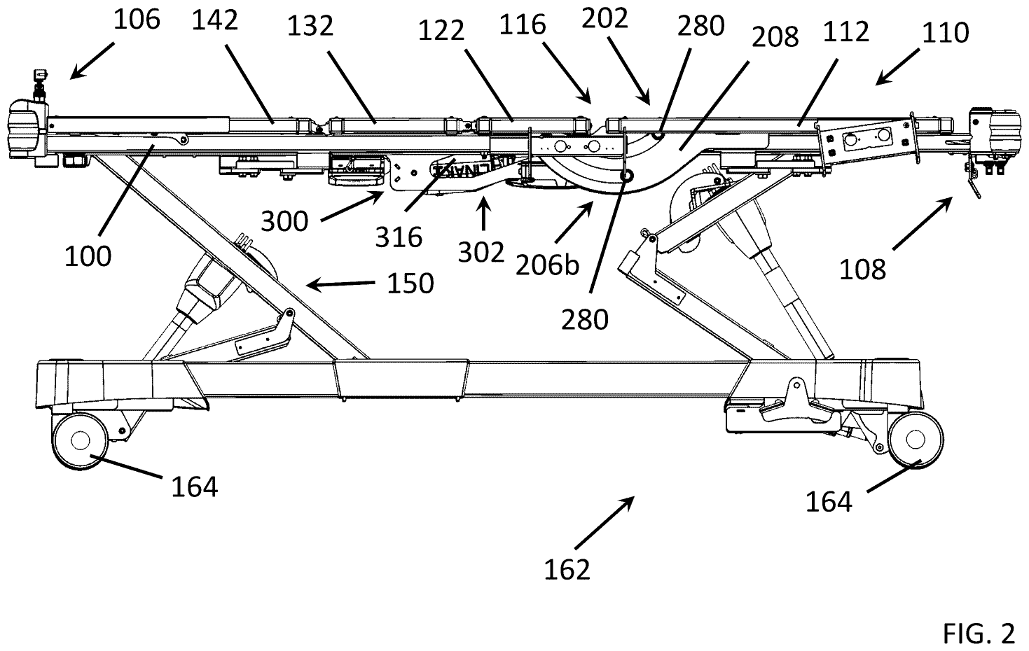

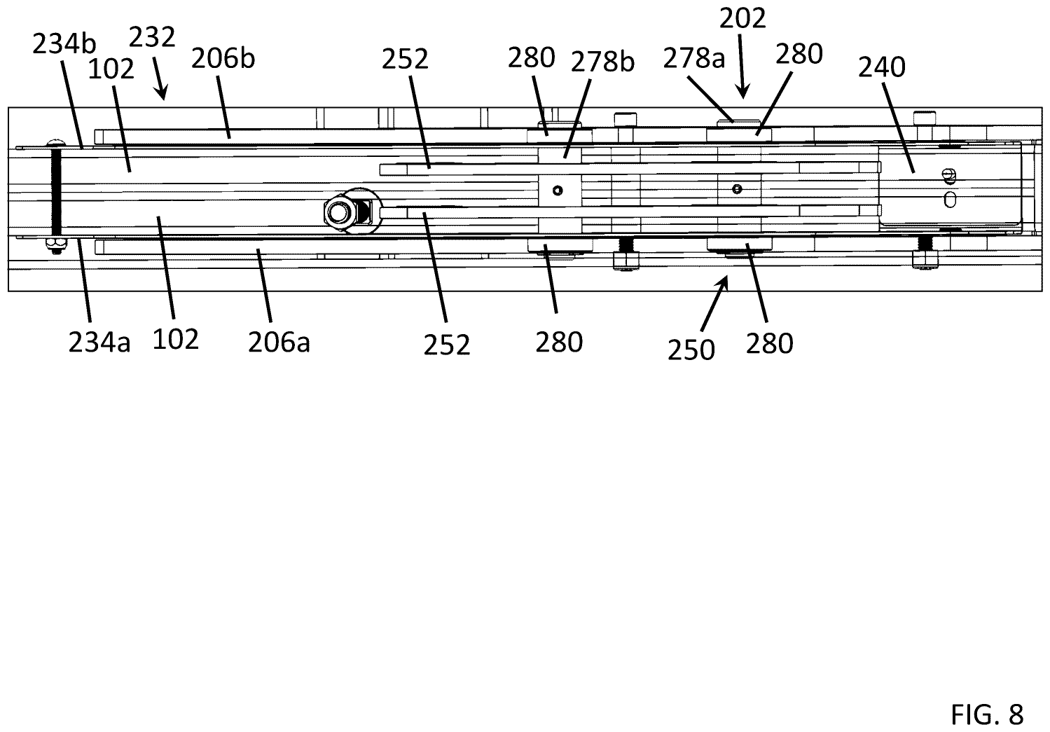

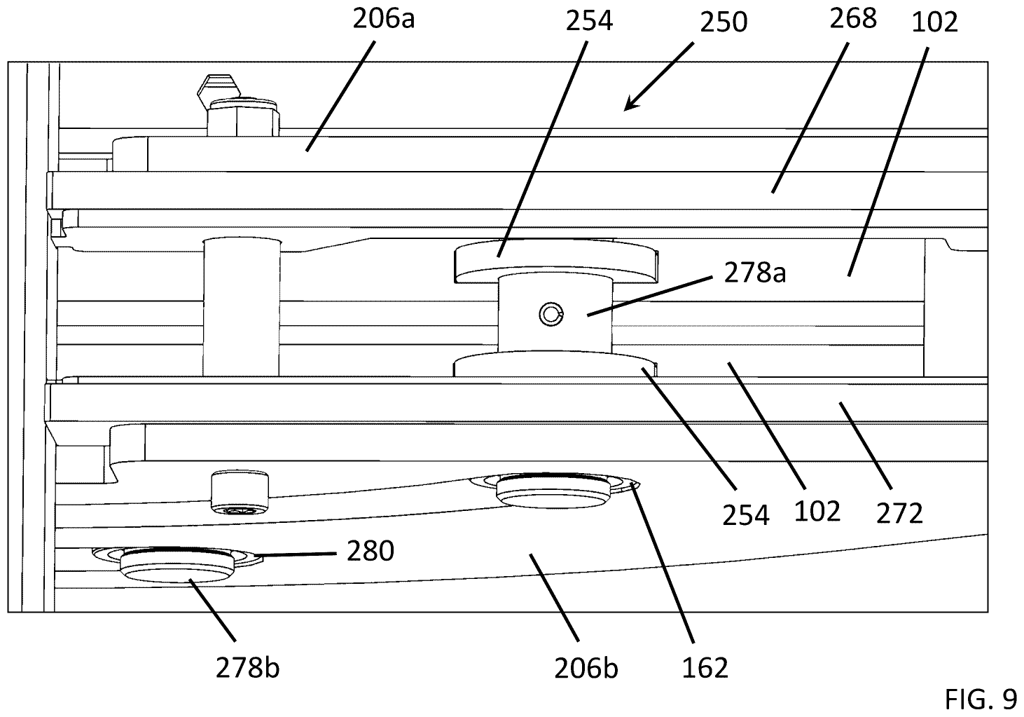

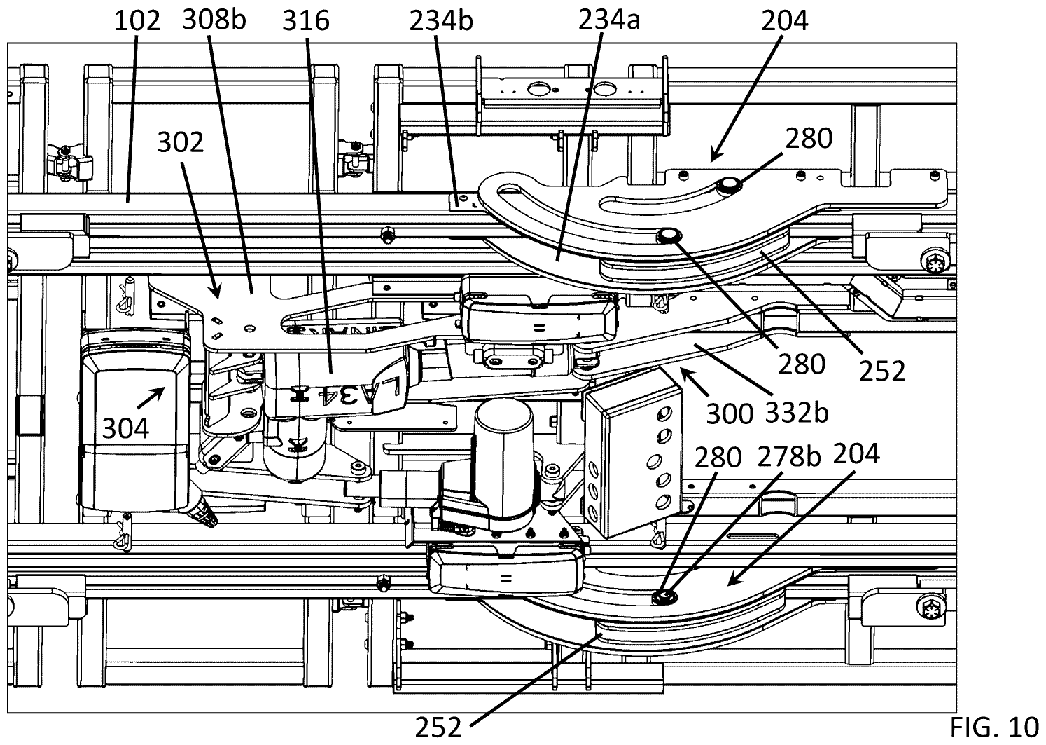

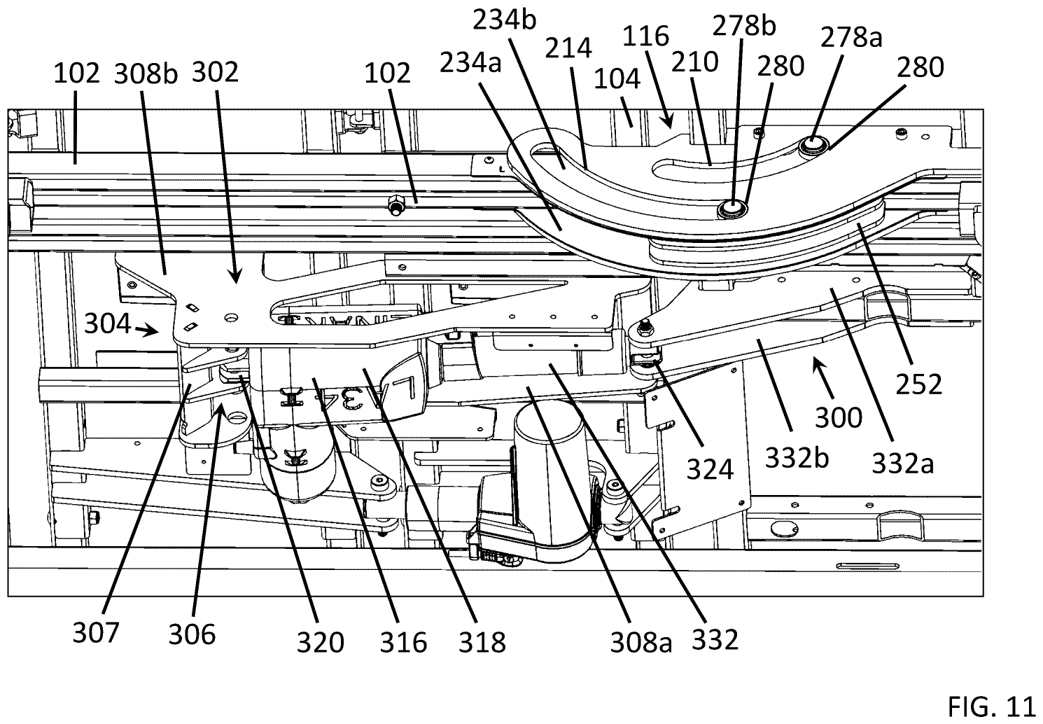

Referring to FIGS. 1-13, an implementation of a parallel support system 200 hinge assembly 202 for use with a bed frame assembly 100 is shown and described. Referring to FIGS. 1-2, the bed frame assembly 100 includes components hingedly connected between a foot end 106 and an opposite head end 108 forming a patient support surface 110. The system 200 and arrangement of components provides smooth and stable movement of a head section 112 of a patient support surface 110 of a bed when the head section 112 is raised and lowered in relation to the bed frame assembly 100 with minimal deflection of the hinge assembly 202. The system 200 allows auto-regression of the head section 112 away from the adjacent upper core section 122 when raised, facilitating patient comfort when profiling the patient from a supine position where the foot section 142, lower core section 132, upper core section 122, and head section 112 provide a generally flat surface parallel with the bed frame assembly 100, to a sitting position where the head section 112 is in an angular position relative to the bed frame assembly 100. The bed frame assembly 100 is connected to a base 162 with ground-contact wheels 164 by an elevation assembly 150. The elevation assembly 150 raises and lowers the patient support surface 110 relative to the ground. In an implementation, the patient is separated from the patient support surface 110 by a mattress.

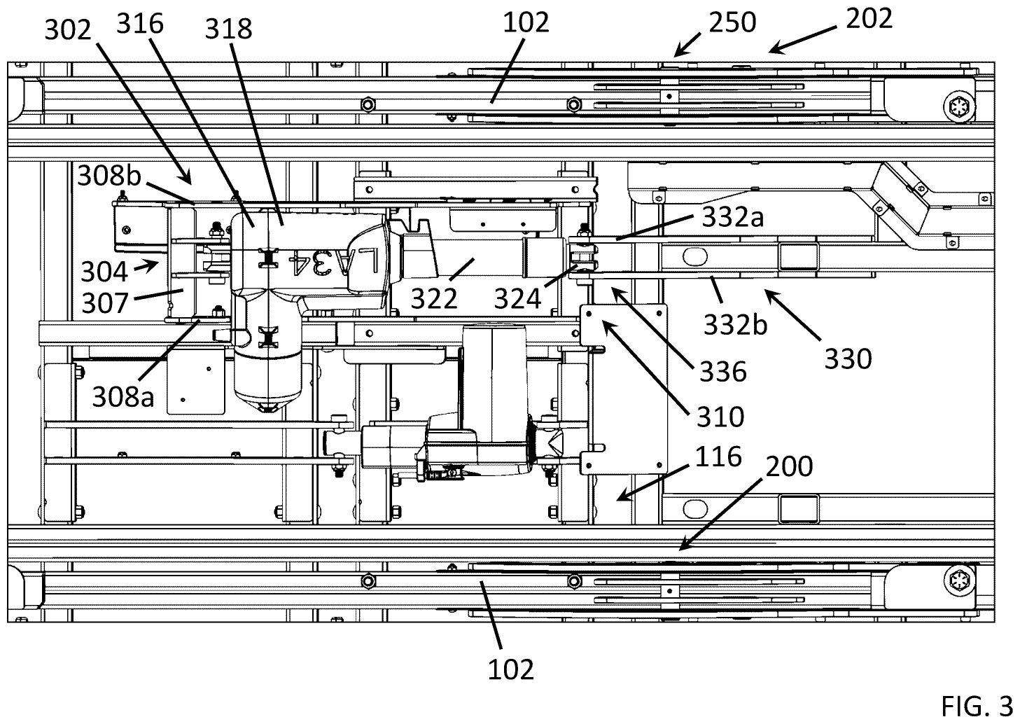

Referring to FIGS. 3, 8-11, and 13, the system 200 uses a pair of hinge assemblies 202. A hinge assembly 202 includes a head section 112 mounted portion and a bed frame assembly 100 mounted portion. The head section 112 mounted portion includes a hinge guide assembly 204 connected to the head section 112 by a hinge support assembly 266. The bed frame assembly 100 mounted portion includes roller bearings 280, such as sealed roller bearings, mounted to the bed frame assembly 100 by a frame plate assembly 232 and a hinge bearing mount assembly 250. The head section 112 mounted portion slidably interfaces with the bed frame assembly 100 mounted portion when moved by an actuation assembly 300.

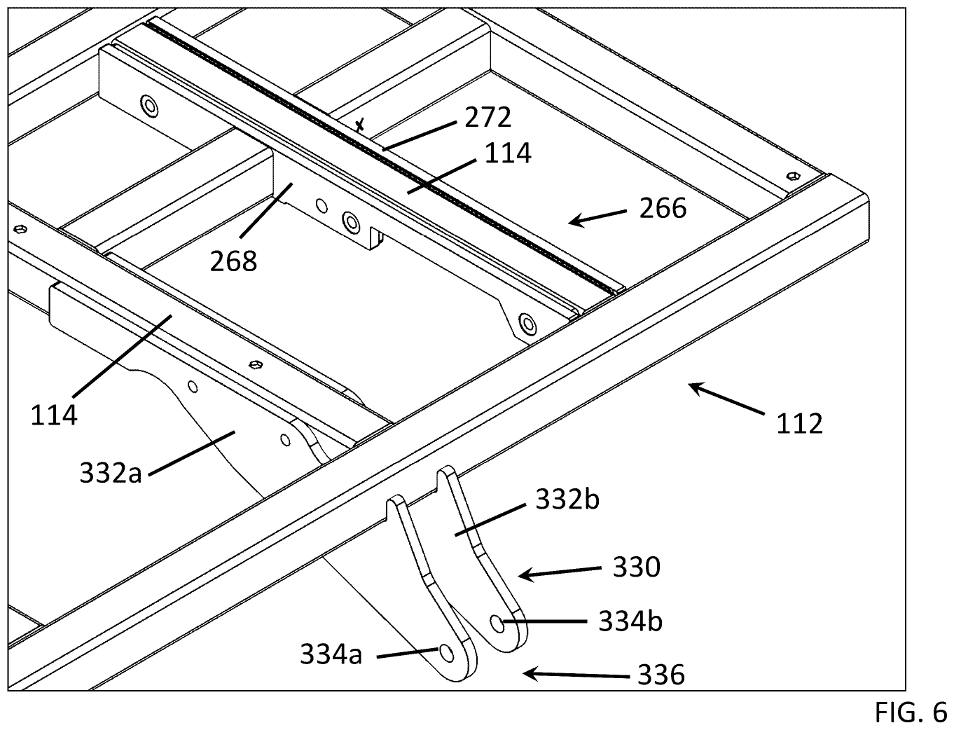

The hinge guide assembly 204 includes a pair of opposing guide plates 206a-b attached to the head section 112 by a hinge support assembly 266. Referring to FIG. 6, a hinge support assembly 266 includes an opposing inner mounting plate 268 and an outer mounting plate 272 that are secured to a vertical member 114 of the head section 112.

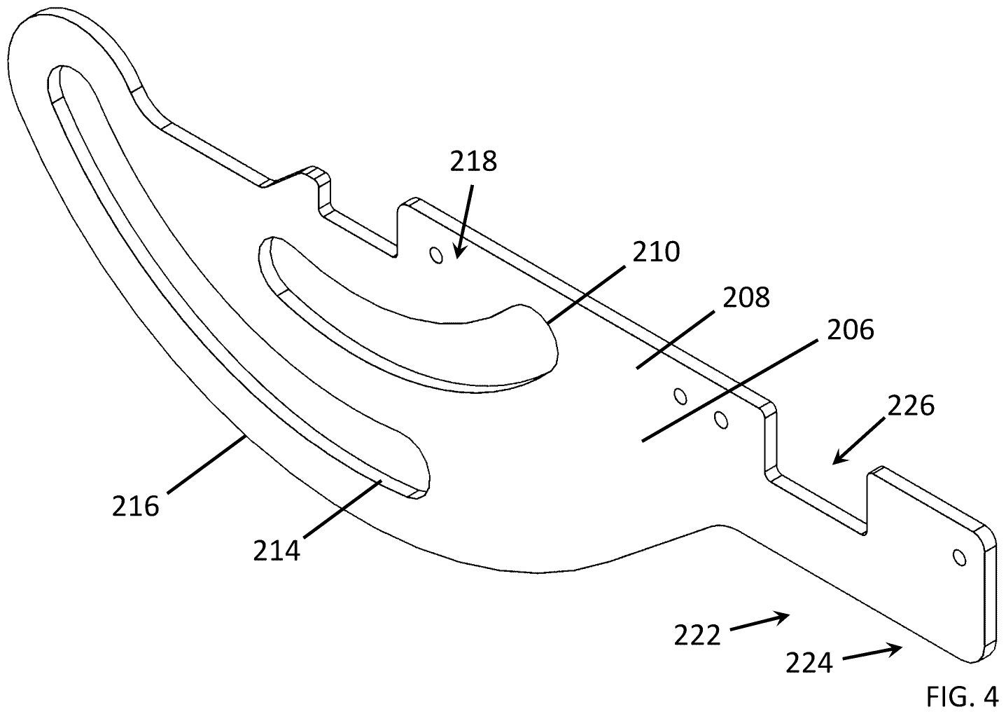

Referring to FIG. 4, a guide plate 206 is an elongated planar structure extending between a first end and a second end, with a head 222 portion disposed at the second end extending from a body 208 portion, with an upper portion 224 of the head 222 forming a notch 226. The body forms a first guide track 210 disposed between the body 208 upper portion 218 and an adjacent second guide track 214. The second guide track 214 is disposed between the first guide track 210 and a bottom edge 216 of the body 208. The second guide track 214 extends from the body 208 first end toward the body 208 second end, terminating below the first guide track 210. The guide tracks 210, 214 are adapted to receive roller bearings 280. In an implementation, the first guide track 210 and second guide track 214 form a curved or a partial circular segment. The guide plate 206 may be formed from stainless steel, and the guide tracks 210, 214 may be zinc-plated.

The guide plates 206a-b move adjacent to frame plates 234a-b disposed between the guide plates 206a-b. In an implementation, the guide plates 206a-b are mounted to the head section 112 via the hinge support assemblies 266 by threaded fasteners.

The roller bearings 280 travel within the guide tracks 210, 214 providing a sliding interface between the head section 112 mounted portion and the bed frame assembly 100 mounted portion when moved by an actuation assembly 300. In an implementation, the roller bearings 280 roll within the guide tracks 210, 214 by making contact with the edge of the guide tracks. The disclosed hinge assembly 202 allows the head section 112 to rotate upward and downward in an angular fashion relative to the bed frame assembly 100. The hinge assembly 202 arrangement of roller bearings 280 within guide tracks 210, 214 results in an angular rotation of the head section 112 relative to the bed frame assembly 100, and limits undesirable vertical movement of the head section 112 encountered with traditional pivoting hinge arrangements used to support head sections of traditional beds.

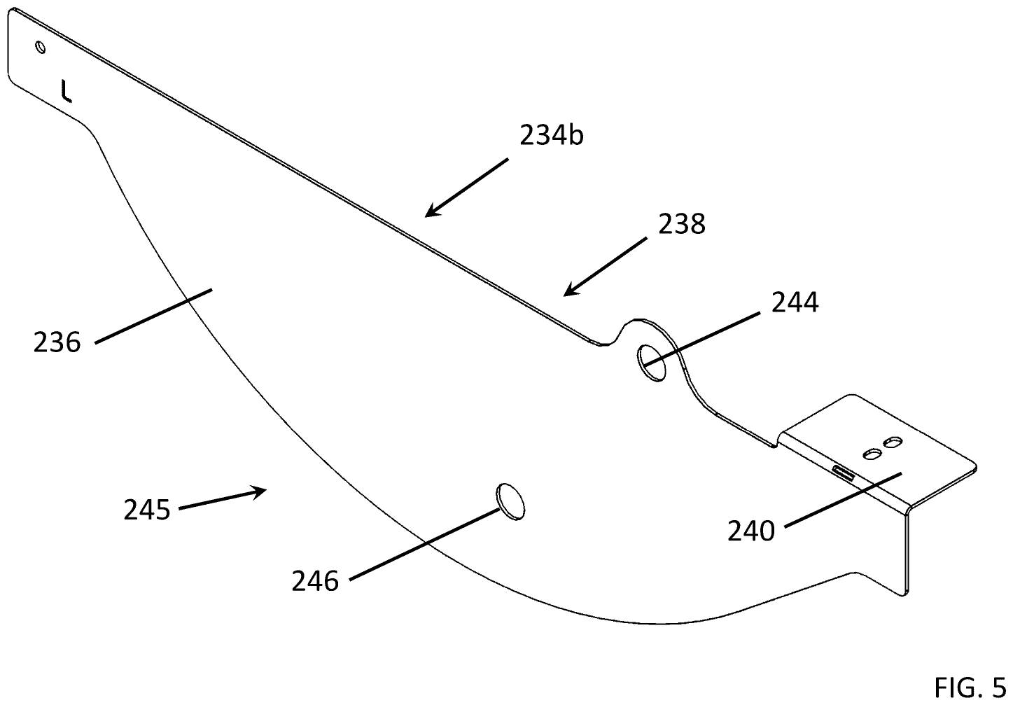

The frame plates 234a-b and bearing mounts 252a-b support the roller bearings 280 in a fixed position relative to the guide plates 206a-b. Referring to FIG. 5, a frame plate 234 has a body 236 forming an upper portion 238 and a lower portion 245. The upper portion 238 forms a first aperture 244 for receiving an upper bearing shaft 278a, and the lower portion 245 forms a second aperture 246 for receiving a lower bearing shaft 278b. A top plate 240 extends from the upper portion 238 for securing the frame plate 234 to the vertical member 114.

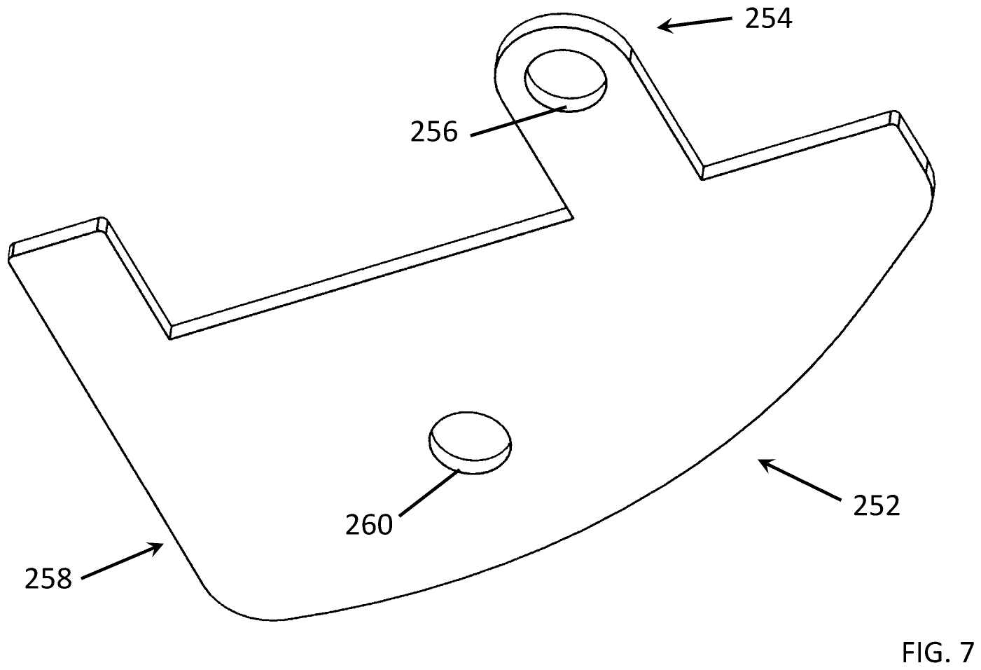

Referring to FIG. 7, a bearing mount 252 forms an upper portion 254 with an aperture 256 for receiving the upper bearing shaft 278a, and a lower portion 258 with an aperture 260 for receiving the lower bearing shaft 278b. The upper portion 254 extends through a vertical support member 102 of the bed frame assembly 100 and extends generally above the upper surface of the vertical support member 102, with the aperture 256 receiving the bearing shaft 278a of a first or upper roller bearing 280. The lower portion 258 extends below the vertical support member 102, with the aperture 260 receiving the bearing shaft 278b of a second or lower roller bearing 280, thereby positioning the first roller bearing 280 above the support member 102 and the second roller bearing 280 below the support member 102.

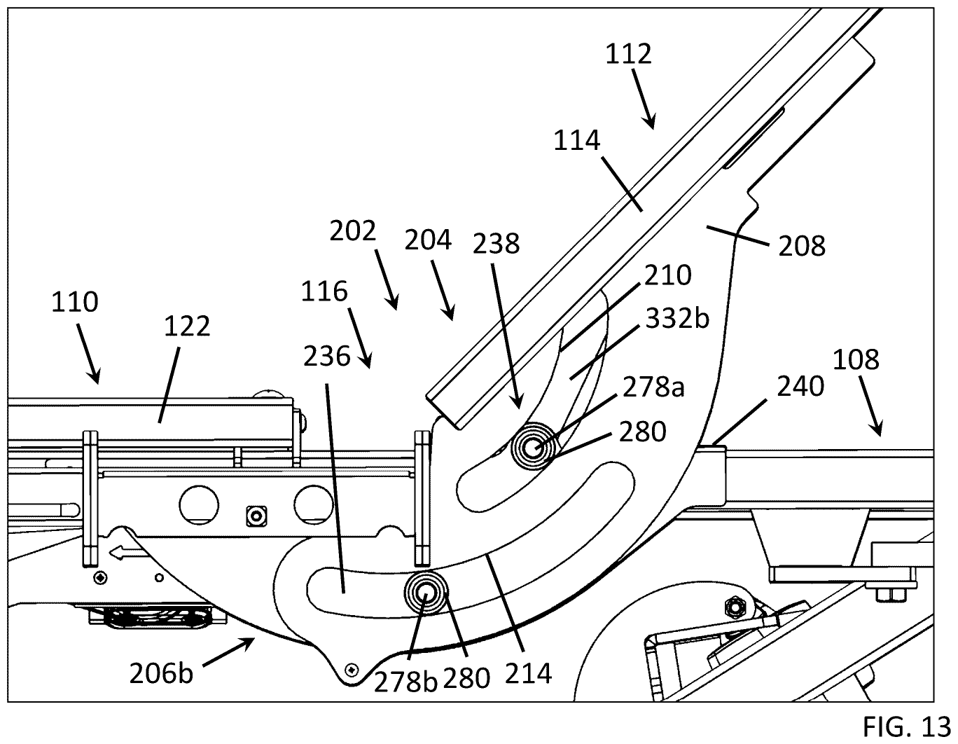

The actuation assembly 300 moves the patient support surface 110 portion of the head section 112 between, and at any point along the path of travel between, a generally flat position (FIG. 1) to a position at an angle relative to the bed frame assembly 100 (FIG. 13). The actuation assembly 300 includes an actuator assembly 316 connected to the bed frame assembly 100 by a bed frame bracket 302, and connected to the head section 112 by a drive assembly bracket 330.

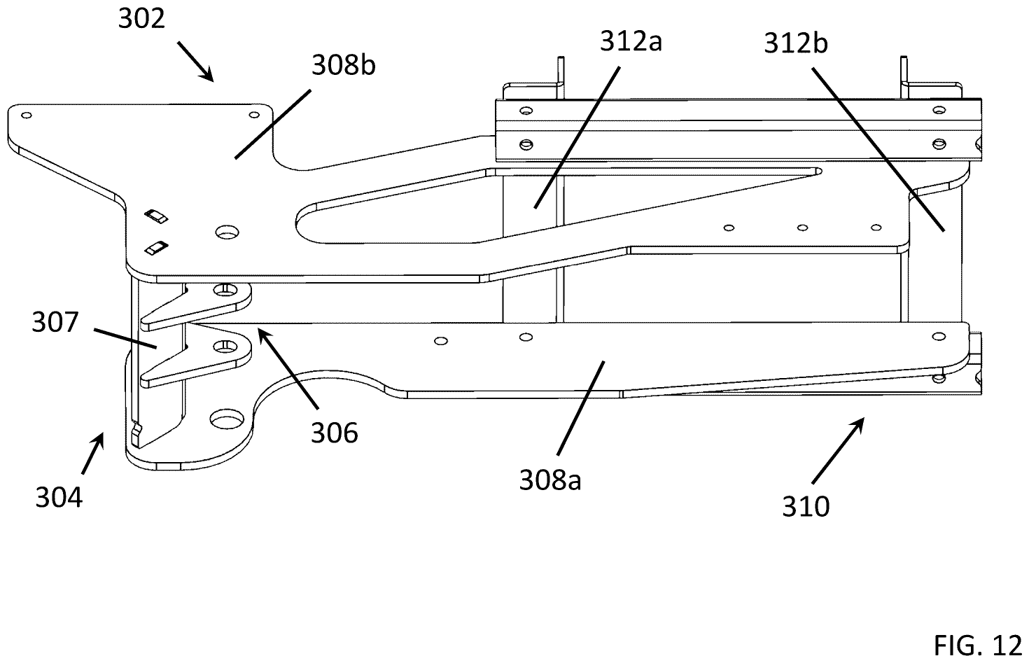

Referring to FIG. 12, the bed frame bracket 302 is mounted adjacent the upper core section 122 opposite a support surface gap 116. The bracket 302 has a first end 304 with a clevis 306 for attachment of the first end 320 of an actuator 318, and a second end 310 with bracket frame elements 312a-b for connecting to the bed frame assembly 100 lateral members 104. The first end 304 and second end 310 are connected by opposing side plates 308a-b, forming a box-like structure. The clevis 306 structure extends from a baseplate 307. The base plate 307 has an L-shaped cross-section adding rigidity to the first end 304 and provides a stable connection between the frame bracket 302 and actuator assembly 316 to avoid deflection of the actuation assembly 300 when the actuator assembly 316 operates.

The drive assembly bracket 330 (FIG. 6) attaches to a vertical member 114 of the head section 112. Opposing first and second plates 332a and 332b include apertures 334a and 334b and form a clevis 336 for attachment of the actuator assembly 316 second end 324.

The opposing guide plates 206a-b of the head section 112 mounted portion capture the bed frame assembly 100 mounted portion therebetween, providing lateral rigidity and stability to the hinge assembly 202 and the hinged connection between the head section 112 and bed frame assembly 100. The pair of dual bearings 280 of each hinge guide assembly 204 provide a smooth and stable movement of the head section 112 when it is moved from the supine position to a sitting position.

The actuator assembly 316 includes an actuator body 318 with a first end 320 hingedly connected to the clevis 306, and a shaft 322 operably connected to the actuator body 318, with a second end 324 hingedly connected to the clevis 336. The second end 324 of the shaft 322 extends from the body 318. In an implementation, the shaft 322 extends axially from the body 318 providing a push-pull force between brackets 302 and 330.

The invention claimed is:

1. A hinge assembly for use with a bed having a head section movable with respect to a bed frame assembly, the bed frame assembly including a support member, the hinge assembly comprising:
a head section mounted portion, comprising:
a hinge guide assembly;
a bed frame assembly mounted portion, comprising:
a hinge bearing mount assembly; and
wherein the head section mounted portion interfaces with the bed frame assembly mounted portion.

2. The hinge assembly of claim 1, comprising:
a bearing mounted to the hinge bearing mount assembly; and
wherein the hinge guide assembly forms a curved guide track adapted to receive the bearing.

3. The hinge assembly of claim 1, comprising:
wherein the hinge guide assembly comprises:
a first guide plate forming a first curved guide track and an adjacent second curved guide track;
wherein the hinge bearing mount assembly comprises:
a bearing mount connected to the bed frame assembly support member;
a first bearing; and
a second bearing;
wherein the bearing mount is disposed adjacent the first guide plate;
wherein the first bearing is received by the first guide plate first curved guide track; and
wherein the second bearing is received by the first guide plate second curved guide track.

4. The hinge assembly of claim 3, comprising:
wherein the first bearing is disposed above the bed frame assembly support member; and
wherein he second bearing is disposed below the bed frame assembly support member.

5. The hinge assembly of claim 3, comprising:
wherein the hinge guide assembly further comprises:
a second guide plate disposed adjacent the first guide plate, the second guide plate forming a first curved guide track and an adjacent second curved guide track; and
wherein the bearing mount is disposed between the first guide plate and the second guide plate.

6. The hinge assembly of claim 1, comprising:
wherein the first bearing translates within the first curved guide track; and
wherein the second bearing translates within the second guide track.

7. The hinge assembly of claim 1, comprising:
an actuation assembly operably connected to the bed frame assembly and to the head section; and
wherein actuation of the actuation assembly moves the head section mounted portion relative to the bed frame assembly mounted portion.

8. The hinge assembly of claim 7, comprising:
a bed frame bracket attached to the bed frame assembly;
a drive assembly bracket attached to the head section; and
wherein the actuation assembly is operably connected to the bed frame assembly by the bed frame bracket, and operably connected to the head section by the drive assembly bracket.

9. The hinge assembly of claim 1, comprising:
wherein the head section forms a patient support surface;
a base connected to the bed frame assembly support member, the base comprising:
a ground-contact wheel;
an elevation assembly;
a mattress at the patient support surface; and
wherein the elevation assembly is operably connected to the bed frame assembly support member and the base for raising and lowering the patient support surface.

10. A hinge assembly for use with a bed having a head section movable with respect to a bed frame assembly, the bed frame assembly including a support member, the hinge assembly comprising:
a head section mounted portion, comprising:
a first guide plate forming:
a first curved guide track; and
a second curved guide track adjacent the first curved guide track;
a bed frame assembly mounted portion, comprising:
a first bearing; and
a second bearing disposed adjacent the first bearing;
wherein the first bearing is received by the first guide plate first curved guide track;
wherein the second bearing is received by the first guide plate second curved guide track; and
wherein the hinge assembly provides angular rotation of the head section relative to the bed frame assembly.

11. The hinge assembly of claim 10, comprising:
wherein the head section mounted portion further comprises:
a second guide plate forming:
a third curved guide track; and
a fourth curved guide track adjacent the third curved guide track;
wherein the bed frame assembly mounted portion further comprises:
a third bearing; and
a fourth bearing;
wherein the third bearing is received by the second guide plate third curved guide track; and
wherein the fourth bearing is received by the second guide plate fourth curved guide track.

12. The hinge assembly of claim 11, comprising:
a bearing mount, comprising:
an upper portion for mounting the first bearing and third bearing; and
a lower portion for mounting the second bearing and the fourth bearing; and
wherein the bearing mount is connected to the bed frame assembly support member.

13. The hinge assembly of claim 11, comprising:
wherein the first guide plate further comprises:
a planar body portion; and
wherein the first curved guide track and second curved guide track are formed by the planar body;
wherein the second guide plate further comprises:
a planar body portion; and
wherein the third curved guide track and fourth curved guide track are formed by the planar body.

14. The hinge assembly of claim 10, comprising:
a drive assembly bracket mounted to the head section;
a bed frame bracket mounted to the bed frame;
an actuation assembly operably connected to the drive assembly bracket and bed frame bracket; and
wherein actuation of the actuation assembly moves the head section mounted portion relative to the bed frame assembly mounted portion.

15. The hinge assembly of claim 10, comprising:
wherein the head section forms a patient support surface;
a base connected to the bed frame assembly support member, the base comprising:
a ground-contact wheel;
an elevation assembly;
a mattress at the patient support surface; and
wherein the elevation assembly is operably connected to the bed frame assembly sup-port member and the base for raising and lowering the patient support surface.

16. A hinge assembly for use with a bed having a head section movable with respect to a bed frame assembly, the bed frame assembly including a support member, the hinge assembly comprising:
a head section mounted portion, comprising:
a first guide plate extending from a first end to a second end, the guide plate forming:
a first curved guide track; and
a second curved guide track adjacent the first curved guide track,
wherein the second curved guide track extends from the first end toward the second end and terminating below the first guide track;
a bed frame assembly mounted portion, comprising:
a first bearing; and
a second bearing disposed adjacent the first bearing;
wherein the first bearing is received by the first guide plate first curved guide track;
wherein the second bearing is received by the first guide plate second curved guide track; and
wherein the hinge assembly provides angular rotation of the head section relative to the bed frame assembly.

17. The hinge assembly of claim 16, comprising:
wherein the bed frame assembly mounted portion comprises:
a bearing mount forming an upper portion and a lower portion;
wherein the upper portion is disposed above the bed frame assembly support member and is adapted for mounting the first bearing; and
wherein the lower portion is disposed below the bed frame assembly support member and is adapted for mounting the second bearing; and
wherein the upper portion extends through the bed frame assembly support member.

18. The hinge assembly of claim 17, comprising:
wherein the first bearing is mounted to the upper portion by a bearing shaft; and
wherein the second bearing is mounted to the lower portion by a bearing shaft.

19. The hinge assembly of claim 17, comprising:
a frame plate disposed between the first bearing and the bearing mount.

20. The hinge assembly of claim 19, comprising:
wherein the frame plate forms a top plate for mounting the frame plate to the bed frame assembly support member.
